(19) United States
(12) Patent Application Publication
(10) Pub. No.: US 2026/0171455 A1
(43) Pub. Date: Jun. 18, 2026

(54) REDOX FLOW BATTERY SYSTEM WITH ANCILLARY CELL FOR pH ADJUSTMENT

(71) Applicant: RTX CORPORATION, Arlington, VA (US)

(72) Inventor: James Demetrios Saraidaridis, South Glastonbury, CT (US)

(21) Appl. No.: 18/983,444

(22) Filed: Dec. 17, 2024

(51) Int. Cl. H01M 8/18

(52) U.S. Cl. CPC H01M 8/188

(57) ABSTRACT

A redox flow battery system includes a redox flow battery (RFB) and an ancillary cell. The ancillary cell includes an anode fluidly connected with the RFB to receive a first electrolyte solution, a cathode fluidly connected with the RFB to receive a second electrolyte solution, and an ionic diode membrane between the anode and the cathode. The ancillary cell serves to control pH of the electrolytes.

### STATEMENT REGARDING FEDERALLY SPONSORED RESEARCH OR DEVELOPMENT

This invention was made with Government support under DE-EE0009794 award by the Department of Energy. The government has certain rights in the invention.

### BACKGROUND

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

A basic flow battery includes a redox flow cell having a negative electrode and a positive electrode separated by an ion-exchange membrane. A negative electrolyte is delivered to the negative electrode and a positive electrolyte is delivered to the positive electrode to drive an electrochemically reversible redox reaction. Upon charging, the electrical energy supplied causes an electrochemical reduction reaction in one electrolyte and an oxidation reaction in the other electrolyte. The ion-exchange membrane prevents the electrolytes from mixing but permits selected ions to pass through to maintain electroneutrality. Upon discharge, the chemical energy contained in the electrolyte is released in the reverse reactions and electrical energy can be drawn from the electrodes.

### SUMMARY

A redox flow battery system according to an example of the present disclosure includes a redox flow battery that has first and second electrolyte solutions, and an ancillary cell that includes an anode fluidly connected with the redox flow battery to receive the first electrolyte solution, a cathode fluidly connected with the redox flow battery to receive the second electrolyte solution, and an ionic diode membrane between the anode and the cathode.

In a further embodiment of any of the foregoing embodiments, the first electrolyte solution has a first electrochemically active species, and the second electrolyte solution has a second electrochemically active species that is chemically different from the first electrochemically active species.

In a further embodiment of any of the foregoing embodiments, the first electrochemically active species and the second electrochemically active species are non-vanadium-based.

In a further embodiment of any of the foregoing embodiments, the ionic diode membrane has a multi-layer construction.

In a further embodiment of any of the foregoing embodiments, the ionic diode membrane includes a layer of polybenzimidazole.

In a further embodiment of any of the foregoing embodiments, the ionic diode membrane includes a layer of perfluorosulfonic acid.

In a further embodiment of any of the foregoing embodiments, the ionic diode membrane includes a first layer of polybenzimidazole and a second layer of perfluorosulfonic acid.

In a further embodiment of any of the foregoing embodiments, the first layer is in interfacial contact with the second layer.

In a further embodiment of any of the foregoing embodiments, the multi-layer construction is a two-layer construction.

In a further embodiment of any of the foregoing embodiments, the anode is electrically short-circuited with the cathode.

A further embodiment of any of the foregoing embodiments further comprises at least one sensor exposed to at least one of the first electrolyte solution and the second electrolyte solution.

In a further embodiment of any of the foregoing embodiments, the at least one sensor is configured to generate signals representing a pH of the at least one of the first electrolyte solution and the second electrolyte solution.

A further embodiment of any of the foregoing embodiments further comprises a controller in communication with the at least one sensor, the controller configured to determine the pH based on the signals.

In a further embodiment of any of the foregoing embodiments, the controller is configured to determine whether the pH is outside of a target pH range and, responsive to the pH being outside the target pH range, instigate a pH correction action in the ancillary cell, the pH correction action in the ancillary cell adjusting the pH toward the target pH range.

In a further embodiment of any of the foregoing embodiments, the pH correction action includes activating a switch to close an electric circuit between the anode and the cathode to cause a short-circuit.

In a further embodiment of any of the foregoing embodiments, subsequent to the pH correction action, the controller is configured to determine whether the pH is inside of the target pH range and, responsive to the pH being inside the target pH range, cease the pH correction action in the ancillary cell.

In a further embodiment of any of the foregoing embodiments, the cease of the pH correction action includes deactivating the switch to open the electric circuit.

In a further embodiment of any of the foregoing embodiments, the redox flow battery includes a redox flow battery cell having first and second electrodes, an ion-exchange layer arranged between the first and second electrodes, first and second circulation loops fluidly connected with, respectively, the first and second electrodes, and first and second electrolyte storage vessels in, respectively, the first and second circulation loops, the first electrolyte solution contained in the first circulation loop and the second electrolyte solution contained in the second circulation loop, the redox flow battery cell supporting electrochemically reversible redox reactions of the first electrolyte solution and the second electrolyte solution.

In a further embodiment of any of the foregoing embodiments, the ancillary cell includes a first feed line fluidly connecting the first electrolyte storage vessel with the anode, and a second feed line fluidly connecting an outlet line in the second circulation loop from the redox flow battery cell with the cathode.

The present disclosure may include any one or more of the individual features disclosed above and, or below alone or in any combination thereof.

### BRIEF DESCRIPTION OF THE DRAWINGS

The various features and advantages of the present disclosure will become apparent to those skilled in the art from the following detailed description. In this disclosure, like reference numerals designate like elements where appropriate and reference numerals with the addition of one-hundred or multiples thereof designate modified elements that are understood to incorporate the same features and benefits of the corresponding elements. The drawings that accompany the detailed description can be briefly described as follows.

FIG. 1 illustrates a flow battery system that has an ancillary cell for controlling pH of electrolyte of a redox flow battery.

FIG. 2 illustrates a sectioned view of an ionic diode membrane.

### DETAILED DESCRIPTION

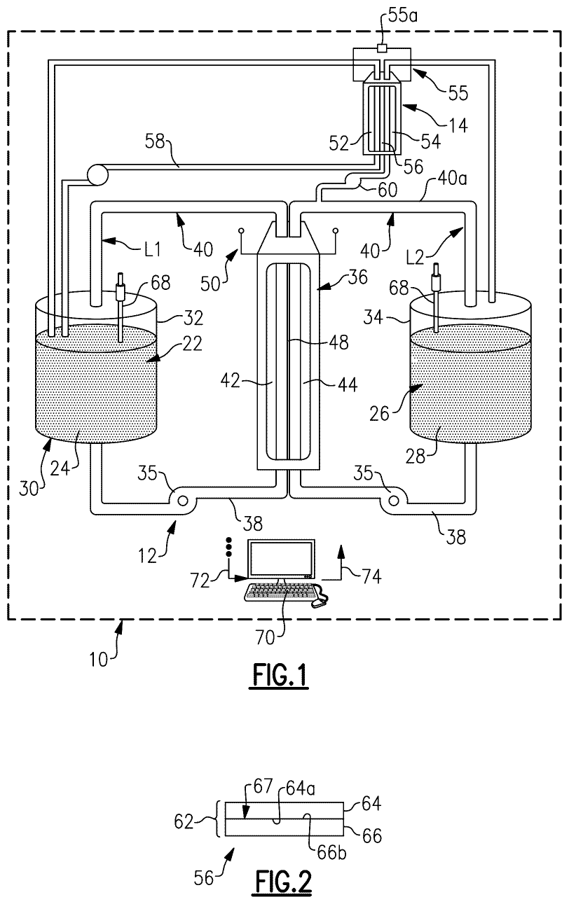

FIG. 1 schematically shows portions of an example redox flow battery system 10 that includes a redox flow battery 12 (“RFB 12”) for selectively storing and discharging electrical energy and an ancillary cell 14 for adjusting the pH of electrolytes used in the flow battery 12. As an example, the RFB 12 is operable to convert electrical energy to chemical energy. At a later time, the RFB 12 is operable to convert the chemical energy back into electrical energy that may be provided to an electric grid, for example. The RFB 12 thus provides for electrical energy storage.

The RFB 12 includes a first electrolyte solution 22 that has at least one electrochemically active species 24 that functions in a redox pair with regard to a second electrolyte solution 26 that has at least one electrochemically active species 28. The electrochemically active species 24, 28 include ions that have multiple, reversible oxidation states in a selected base solvent, such as but not limited to, water, acetonitrile, dimethoxyethane, and propylene carbonate. In some examples, the multiple oxidation states are non-zero oxidation states, such as some transition metals.

The transition metals may include, but are not limited to, vanadium, iron, manganese, chromium, zinc, molybdenum, cerium, lead, tin, titanium, germanium, and functional combinations thereof. In some cases, the transition metals can be modified by bound chelating agents, including but not limited to ethylendiaminetetraacetic acid (EDTA) or other aminopolycarboxylic acids, cyano groups, acetylacetonates, bipyridyls, and phenanthrenes. In some examples, the multiple oxidation states can include the zero oxidation state if the molecule or element is readily soluble in the selected liquid solution in the zero oxidation state. Such elements can include the halogens, such as bromine, chlorine, and combinations thereof. The electrochemically active species 24, 28 could also be organic molecules or macromolecules that contain groups that undergo electrochemically reversible oxidation and reduction reactions, such as quinones or nitrogen-containing organics, such as quinoxalines or pyrazines. Generally, the term “electrochemically active species” refers herein to molecules and/or elements that are dissolved in a supporting electrolyte solution that are capable of reversible oxidation and reduction reactions at the electrodes of the RFB 12.

The first electrolyte solution 22 and the second electrolyte solution 26 are contained in a supply and storage system 30 that includes first and second vessels 32 and 34. The electrolyte solutions 22, 26 are circulated by pumps 35 to at least one redox flow cell 36 of the RFB 12 through respective feed lines 38, and are returned from the cell 36 to the vessels 32, 34 via respective return lines 40. As can be appreciated, additional pumps 35 can be used if needed, as well as valves (not shown) at the inlets and/or outlets of the components to control flow. In this example, the feed lines 38 and the return lines 40 connect the vessels 32, 34 in respective circulation loops L1, L2 with first and second electrodes 42, 44 of the cell 36. Multiple cells 36 can be provided as a stack within the circulation loops L1, L2. In the illustrated example, the first electrode 42 corresponds to an anode and the first electrolyte solution 22 is a negative anolyte. The second electrode 44 corresponds to a cathode and the second electrolyte solution 26 is a positive catholyte.

The cell 36 includes the anode 42, the cathode 44 spaced apart from the anode 42, and a barrier layer 48 arranged between the anode 42 and the cathode 44. For example, the anode 42 and cathode 44 may be porous electrically-conductive structures, such as carbon paper or felt. The cell 36 may further include flow fields (not shown) adjacent the anode 42 and cathode 44, respectively, for delivering the electrolytes 22, 26.

The barrier layer 48 can be, but is not limited to, an ionic-exchange membrane, a micro-porous polymer membrane, or an electrically insulating microporous matrix of a material, such as silicon carbide (SiC), that prevents the electrolytes 22, 26 from freely and rapidly mixing but permits selected ions to pass through to complete the redox reactions while electrically isolating the anode 42 and cathode 44. In this regard, the circulation loops L1, L2 are fluidly isolated from each other during normal operation, such as charge, discharge and shutdown states.

The electrolytes 22, 26 are delivered to, and circulate through, the cell 36 or cells 36 during an active charge mode and discharge mode to either convert electrical energy into chemical energy or, in the reverse reaction, convert chemical energy into electrical energy that is discharged. The electrical energy is transmitted to and from the cell 36 or cells 36 through an electric circuit 50 that is electrically coupled with the electrodes 42, 44.

Flow batteries such as RFB 12 operate at target pH conditions for efficient electrochemical reactions and battery durability, which depends on the nature of the electrochemically active species. For example, the electrolytes can be targeted for a “neutral” pH range, such as a pH between 3 and 11. Still, there are often unavoidable “side” reactions that can cause changes in concentrations of hydrogen and/or hydroxide in the electrolytes. Even small changes in concentrations of these can cause substantial swings in pH that can disrupt battery operation, reduce efficiency, and reduce durability.

In some battery chemistries, the pH can be readily managed. For instance, in all-vanadium RFB chemistries, the positive and negative electrolytes can be mixed together and then redistributed to the storage vessels. However, this mixing approach is only effective where the species are the same (i.e., the same base species). In this case, mixing of vanadium electrolytes results in self-discharge of the electrolytes, but as long as the self-discharge is an acceptable loss, there are no chemically detrimental effects, as the electrolytes can subsequently be recharged to full capacity. In contrast, where the positive and negative species are not the same (e.g., ligand-modified metal compounds using different metal centers or ligands), the mixing approach may not be effective because the species, when mixed together, may react to form solid precipitates. In that case, the electrolytes cannot subsequently be recharged. In this regard, as described in the examples below, the ancillary cell 14 enables adjustment of pH without mixing the electrolytes together.

As indicated, use of the ancillary cell 14 may be most effective for electrolytes that cannot be mixed together, although it should be appreciated that the ancillary cell 14 could also be used with electrolytes that can be mixed. For instance, the active species 24, 28 of the respective electrolytes 22, 26 are chemically different from each other. In one example, the active species 24 is based on ligand modified chromium (e.g., chromium coordinated 1,3-propanediaminetetraacetate) and the active species 28 is based on ligand modified iron (e.g., ferrocyanide). It is to be appreciated that the active species 24, 28 are not limited to these but in general will involve active materials or dissimilar composition (as opposed to acidic, all vanadium chemistries), particularly those that are reactive with each other to form precipitates.

The ancillary cell 14 includes an anode 52 fluidly connected with the RFB 12 to receive the first electrolyte solution 22, a cathode 54 fluidly connected with the RFB 12 to receive the second electrolyte solution 26, and an ionic diode membrane 56 between the anode 52 and the cathode 54. The anode 52 is electrically connected with the cathode 54 in a circuit 55 so as to be electrically short-circuited. The circuit 55 may include a switch 55a that serves to selectively open and close the circuit 55, which is discussed in more detail below. An ionic diode membrane is a membrane that permits directional selectivity for ion transport, i.e., target ions can be transported in one direction more easily through the membrane than the opposite direction. In this case, the ionic diode membrane 56 is selective for one-way hydrogen and/or hydroxide transport between the anode 52 and the cathode 54, but hinders transport of other molecules across the ionic diode membrane 56.

The ancillary cell 14 includes a first feed line 58 fluidly connecting the first electrolyte storage vessel 32 with the anode 52, and a second feed line 60 fluidly connecting an outlet line 40a in the second circulation loop L2 from the redox flow battery cell 36 with the cathode 54. Thus, the anode 52 of the ancillary cell 14 can receive the first electrolyte solution 22 directly from the storage vessel 32 and the cathode 54 can receive the second electrolyte solution 26 that exits from the cell 36, before it circulates back into the vessel 34. Alternatively, the anode 52 of the ancillary cell 14 can receive the first electrolyte solution 22 from the electrolyte solution 22 that exits from the cell 36 and the cathode 54 can receive the second electrolyte solution 26 directly from the storage vessel 34. In further alternatives, both the anode 52 and the cathode 54 receive the electrolyte solutions 22, 26 directly from the respective storage vessels 32, 34, or the both anode 52 and the cathode 54 receive the electrolyte solutions 22, 26 directly from the exits of the cell 36.

FIG. 2 illustrates a representative sectioned view of the ionic diode membrane 56. As shown, the membrane 56 has a multi-layer construction 62. In this example, the multi-layer construction 62 is a two-layer construction that has a first layer 64 and a second layer 66. The layers 64, 66 are situated adjacent one another such that there is interfacial contact at contact interface 67 between the sides 64a, 64b of the respective layers 64, 66. Although there is this physical contact, the layers 64, 66 are not, and need not be, bonded together along the contact interface 67.

In one example, the layer 64 is a layer of polybenzimidazole (PBI). In another example, the layer 66 is a layer of perfluorosulfonic acid (“PFSA”), such as PFSA known under the tradename of NAFION from The Chemours Company. In a further example, the layer 64 is PBI and the layer 66 is PFSA. Although this example is a two-layer construction, further examples additionally include one or more additional layers 64 and/or 66 of PBI, PFSA, or other ionic membrane material.

The system 10 can also further include components for automated and/or controlled operation of the ancillary cell 14. For example, there is at least one sensor 68 that is exposed to at least one of the electrolyte solutions 22, 26. For example, the sensors 68 are electronic pH meters and are located in the vessels 32, 34. Alternatively, the sensors 68 are located in the lines 38, 40 or in the cell 36.

The sensor 68 is operable to generate signals representative of the pH of the electrolyte 22, 26. The sensor 68 is in communication with a controller 70, such as a computer or a tablet. The controller 70 includes at least one electronic processor and at least one memory device. The processor has an electrical input 72 for receiving the signals from the sensor 68, and at least one electrical output 74 for sending out control signals. The memory device is coupled to the processor and contains instructions stored therein. The processor is configured to access the memory device and to execute the instructions stored therein to perform the described functions. Alternatively, different functions of the controller 70 may be embodied in, or hosted in, multiple processors or computational devices, any or all of which may be accessible over a server.

The controller 70 is configured to determine the pH of one or both of the electrolyte solutions 22, 26 and then determine whether the pH is outside of a target pH range. For example, the determined pH is compared with a pH range from a lookup table in the memory device. The controller 70, responsive to the pH being outside the target pH range, instigates a pH correction action in the ancillary cell 14.

For example, the controller 70 is in communication with the switch 55a, and sends a control signal to the switch 55a to activate the switch 55a to either open or close. The terms “activate” and “deactivate” are not intended herein to imply or require any particular state of powering of the switch 55a. In other words, an electric current may close the switch 55a and zero current may open the switch, or vice versa, or multiple non-zero power levels may be used to close and open the switch 55a. The pH correction action in the ancillary cell 14 adjusts the pH toward the target pH range. For example, if the pH is outside the desired pH range, the controller 70 closes the switch 55a to electrically short-circuit the ancillary cell 14. The short-circuiting permits free electrical discharge of the ancillary cell 14 but is limited by proton and/or hydroxide transport across the ionic diode membrane 56, resulting in a change in concentration of hydrogen and/or hydroxide in the electrolytes 22, 26 and concomitant change in pH. Generally, the side losing protons will increase in pH, while the side receiving protons with decrease in pH.

The controller 70 may continue to determine the pH during the pH correction and determine whether the pH that was initially outside the target pH range is now inside of the target pH range. Once the pH is inside the target pH range, the controller 70 responsively ceases the pH correction action in the ancillary cell 14 by sending a control signal to the switch 55a to open.

In one further example based on the propanediaminetetraacetate modified chromium and hexacyano modified iron species discussed earlier, the controller 70 instigates the pH control action responsive to the pH reaching or nearing a threshold pH of 10 in the chromium electrolyte or below pH 5 in the iron electrolyte. The above species may start to precipitate at pH 10 or decompose below pH 5, respectively. Therefore, in order to avoid reaching or exceeding the threshold, the controller 70 instigates the pH control action to adjust the pH.

As will be appreciated, the ancillary cell 14 can additionally or alternatively be operated manually, wherein a human operator measures pH of one or both of the electrolytes 22, 26 and, if the pH is outside of the target pH, activates the switch 55a to close the circuit 55 and adjust the pH. The operator subsequently deactivates the switch 55a to open the circuit 55 once the pH is at the desired target level.

Although a combination of features is shown in the illustrated examples, not all of them need to be combined to realize the benefits of various embodiments of this disclosure. In other words, a system designed according to an embodiment of this disclosure will not necessarily include all of the features shown in the Figure or all of the portions schematically shown in the Figure. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A redox flow battery system comprising:
a redox flow battery including first and second electrolyte solutions; and
an ancillary cell including an anode fluidly connected with the redox flow battery to receive the first electrolyte solution, a cathode fluidly connected with the redox flow battery to receive the second electrolyte solution, and an ionic diode membrane between the anode and the cathode.

2. The redox flow battery system as recited in claim 1, wherein the first electrolyte solution has a first electrochemically active species, and the second electrolyte solution has a second electrochemically active species that is chemically different from the first electrochemically active species.

3. The redox flow battery system as recited in claim 1, wherein the first electrochemically active species and the second electrochemically active species are non-vanadium-based.

4. The redox flow battery system as recited in claim 1, wherein the ionic diode membrane has a multi-layer construction.

5. The redox flow battery system as recited in claim 4, wherein the ionic diode membrane includes a layer of polybenzimidazole.

6. The redox flow battery system as recited in claim 4, wherein the ionic diode membrane includes a layer of perfluorosulfonic acid.

7. The redox flow battery system as recited in claim 4, wherein the ionic diode membrane includes a first layer of polybenzimidazole and a second layer of perfluorosulfonic acid.

8. The redox flow battery system as recited in claim 7, wherein the first layer is in interfacial contact with the second layer.

9. The redox flow battery system as recited in claim 4, wherein the multi-layer construction is a two-layer construction.

10. The redox flow battery system as recited in claim 1, wherein the anode is electrically short-circuited with the cathode.

11. The redox flow battery system as recited in claim 1, further comprising at least one sensor exposed to at least one of the first electrolyte solution and the second electrolyte solution.

12. The redox flow battery system as recited in claim 11, wherein the at least one sensor is configured to generate signals representing a pH of the at least one of the first electrolyte solution and the second electrolyte solution.

13. The redox flow battery system as recited in claim 12, further comprising a controller in communication with the at least one sensor, the controller configured to determine the pH based on the signals.

14. The redox flow battery system as recited in claim 13, wherein the controller is configured to determine whether the pH is outside of a target pH range and, responsive to the pH being outside the target pH range, instigate a pH correction action in the ancillary cell, the pH correction action in the ancillary cell adjusting the pH toward the target pH range.

15. The redox flow battery system as recited in claim 14, wherein the pH correction action includes activating a switch to close an electric circuit between the anode and the cathode to cause a short-circuit.

16. The redox flow battery system as recited in claim 14, wherein, subsequent to the pH correction action, the controller is configured to determine whether the pH is inside of the target pH range and, responsive to the pH being inside the target pH range, cease the pH correction action in the ancillary cell.

17. The redox flow battery system as recited in claim 16, wherein the cease of the pH correction action includes deactivating the switch to open the electric circuit.

18. The redox flow battery system as recited in claim 1, wherein the redox flow battery includes a redox flow battery cell having first and second electrodes, an ion-exchange layer arranged between the first and second electrodes, first and second circulation loops fluidly connected with, respectively, the first and second electrodes, and first and second electrolyte storage vessels in, respectively, the first and second circulation loops, the first electrolyte solution contained in the first circulation loop and the second electrolyte solution contained in the second circulation loop, the redox flow battery cell supporting electrochemically reversible redox reactions of the first electrolyte solution and the second electrolyte solution.

19. The redox flow battery system as recited in claim 18, wherein the ancillary cell includes a first feed line fluidly connecting the first electrolyte storage vessel with the anode, and a second feed line fluidly connecting an outlet line in the second circulation loop from the redox flow battery cell with the cathode.
